(19) United States
(12) Patent Application Publication
(10) Pub. No.: US 2023/0191648 A1
(43) Pub. Date: Jun. 22, 2023

(54) HANDHELD CIRCULAR SAW

(71) Applicant: Evolution Power Tools Limited, Sheffield (GB)

(72) Inventors: Simon DONSON, Sheffield (GB); Ben BATEMAN, Sheffield (GB); Mark STRATFORD, Sheffield (GB); Richard MANNION, Sheffield (GB)

(21) Appl. No.: 17/553,194

(22) Filed: Dec. 16, 2021

(51) Int. Cl. B27G 19/04

(52) U.S. Cl. CPC B27G 19/04

(57) ABSTRACT

There is provided a handheld circular saw comprising a main body. The main body comprises a fixed blade guard configured to receive a circular cutting blade having an axis of rotation. A graspable handle is arranged in a forward position on the main body to enable a user to wield the power tool in use and a movable blade guard is arranged to surround at least a part of the cutting blade. An actuator arrangement configured to move the movable blade guard from a first position to a second position, where a greater proportion of the cutting blade is exposed in the second position than in the first position, the actuator arrangement having an actuator grip to enable the user to activate the actuator arrangement. The actuator grip is located and arranged forwardly of the graspable handle to enable actuation by the fingers of the user's hand which is grasping the graspable handle in use.

### TECHNICAL FIELD

The present invention relates to a handheld circular saw power tool. More particularly, the present invention relates to a handheld circular saw power tool and a blade guard actuation mechanism therefor.

### BACKGROUND

Portable, manually-wielded circular saw power tools are common in a number of applications. They comprise a circular blade which can be used, depending upon configuration, to cut wood, metal or other materials. Such saws are commonly used in the construction and building industry, and in domestic environments, to make cuts with a substantially vertically arranged circular blade which rotates about a generally horizontal axis.

These saw types generally comprise a base plate formed on the power tool, with a part of the blade projecting through a slot in the base plate. The base plate is placed on or adjacent a workpiece to be cut, and the power tool advanced so that the exposed portion of the blade engages with the workpiece to cut it.

### SUMMARY

However, the need to have an exposed portion of the blade, coupled with the handheld nature of these tools, poses potential safety concerns. Therefore, it is known to provide a guard around the lower portion of the blade. The blade guard is arranged to expose only a small arc of the blade and is rotatable away from the workpiece to expose more of the cutting blade as the power tool is advanced through the workpiece.

Commonly, the blade guard is biased into a forward position and then moved rearwards through contact with the workpiece. However, this can lead to issues in use. For example, contact between the blade guard and the workpiece can damage or mark the workpiece.

In addition, if the workpiece has a small depth (e.g. the workpiece comprises a sheet of material to be cut) then there may be an insufficient moment arm between the lower edge of the workpiece and the blade guard to cause the blade guard to rotate. As a result, the workpiece may become lodged between the blade guard and the base plate.

For these reasons, some power tool manufacturers provide a user-actuated control to rotate the guard housing manually. These designs usually comprise a button or trigger which is arranged behind a forward handle of the power tool and is activated by the user's thumb.

When pushed substantially horizontally by a user's thumb, an actuator is caused to push down on a portion of the guard housing forward of the pivot point, causing the guard housing to rotate. However, these designs are generally unergonomic and difficult for a user to operate. A user is often required to apply considerable force using their thumb, and this action can upset the user's balance of, and grip on, the machine.

The present invention seeks, in embodiments, to address the disadvantages of the known art.

According to a first aspect of the present invention, there is provided a handheld circular saw comprising: a main body comprising a fixed blade guard configured to receive a circular cutting blade having an axis of rotation; a graspable handle arranged in a forward position on the main body to enable a user to wield the power tool in use; a movable blade guard arranged to surround at least a part of the cutting blade; and an actuator arrangement configured to move the movable blade guard from a first position to a second position, wherein a greater proportion of the cutting blade is exposed in the second position than in the first position, the actuator arrangement having an actuator grip to enable the user to activate the actuator arrangement, wherein the actuator grip is located and arranged forwardly of the graspable handle to enable actuation by the fingers of the user's hand which is grasping the graspable handle in use.

In one embodiment, the actuator arrangement further comprises an actuator arm arranged to engage with a part of the movable blade guard to move the blade guard from the first position to the second position.

In one embodiment, the actuator arm comprising the actuator grip at a distal end.

In one embodiment, the actuator arm has a pivotable connection to the fixed blade guard at a proximal end thereof.

In one embodiment, the movable blade guard is rotatable between the first and second positions about an axis of rotation.

In one embodiment, the movable blade guard is rotatable about an axis of rotation coincident with the axis of rotation of the cutting blade.

In one embodiment, the actuator arm and movable blade guard comprise complimentary engagement arrangements to facilitate movement therebetween.

In one embodiment, the engagement arrangements are located between the pivotable connection and the axis of rotation of the movable blade guard.

In one embodiment, the engagement arrangements comprise a rotatable bearing on one part and a ramp on the other part.

In one embodiment, the actuator arm comprises the rotatable bearing and the guard housing comprises the ramp.

In one embodiment, the ramp has a straight or a curved profile.

In one embodiment, the rotatable bearing is spaced from the pivotable connection between the pivotable connection and the actuator grip.

In one embodiment, the rotatable bearing is offset from a line connecting the pivotable connection and the actuator grip.

In one embodiment, the engagement arrangements on the actuator arm are arranged below the engagement arrangements on the blade guard such that lifting the actuator arm causes engagement between the complimentary engagement arrangements.

In one embodiment, the handheld circular saw further comprises a base plate connected to a lower end of the main body and arranged such that at least a part of the cutting blade extends below the main body through an aperture in the base plate in use.

In one embodiment, the cutting blade is rotatable about a substantially horizontal axis in use.

In one embodiment, further comprising an electrical motor located within the main body.

In one embodiment, the graspable handle is spaced from the main body.

In one embodiment, the graspable handle is arranged substantially parallel to the axis of rotation of the cutting blade.

In one embodiment, the actuator grip is movable between first and second positions, wherein in the second position the actuator grip is closer to the graspable handle than in the first position.

In one embodiment, the actuator grip is movable between first and second positions in a substantially vertical plane.

In one embodiment, the movable blade guard is movable to a third position beyond the second position, wherein a greater proportion of the cutting blade is exposed in the third position relative to the first and second positions.

According to a second aspect of the present invention, there is provided a handheld circular saw comprising: a main body configured to receive a rotatable circular cutting blade in use; a graspable handle arranged forwardly on the main body to enable a user to wield the power tool in use; and a movable blade guard arranged to surround at least a part of the cutting blade; and an actuator arrangement configured to move the movable blade guard between a first position and a second position, wherein a greater proportion of the blade is exposed in the second position than in the first position, the actuator arrangement having an actuator arm comprising an actuator grip manipulable by a user, wherein the actuator arrangement is configured and arranged such that movement of the actuator arm in a first direction causes the movable blade guard to move in a second direction opposite to the first direction.

In one embodiment, the actuator arrangement is configured and arranged such that rotation of the actuator arm in a first direction causes the movable blade guard to rotate in a second direction of rotation opposite to the first direction of rotation.

### BRIEF DESCRIPTION OF FIGURES

Embodiments of the present invention will now be described in detail with reference to the accompanying drawings, in which:

FIG. 1 shows a front perspective view of a circular saw power tool according to an embodiment of the present invention;

FIG. 2 shows a rear perspective view of the circular saw power tool of FIG. 1;

FIGS. 3 and 4 show respective side views of the circular saw power tool of FIGS. 1 and 2;

FIG. 5 shows a front view of the circular saw power tool of FIGS. 1 to 4;

FIG. 6 shows a side section view through the circular saw power tool of FIGS. 1 to 5 taken through a plane parallel to plane Y-Y shown in FIG. 5;

FIG. 7 shows a close up view of a handle and actuator arrangement of the circular saw power tool of FIGS. 1 to 6;

FIGS. 8 and 9 show perspective and side section views of the circular saw power tool of FIGS. 1 to 7 taken along substantially horizontal plane;

FIGS. 10 and 11 show an actuator arrangement and movable blade guard in a first position removed from the circular saw power tool of FIGS. 1 to 9; and

FIGS. 12a, 12b and 12c show the movable blade guard in the first, second and third positions respectively.

### DETAILED DESCRIPTION

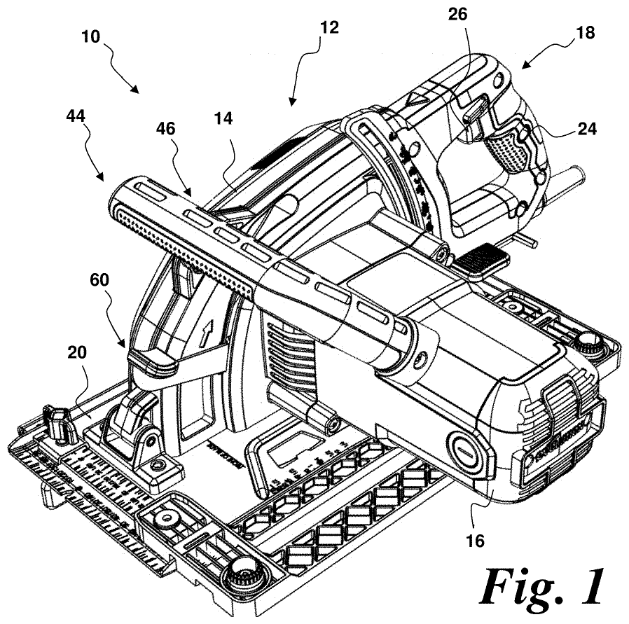

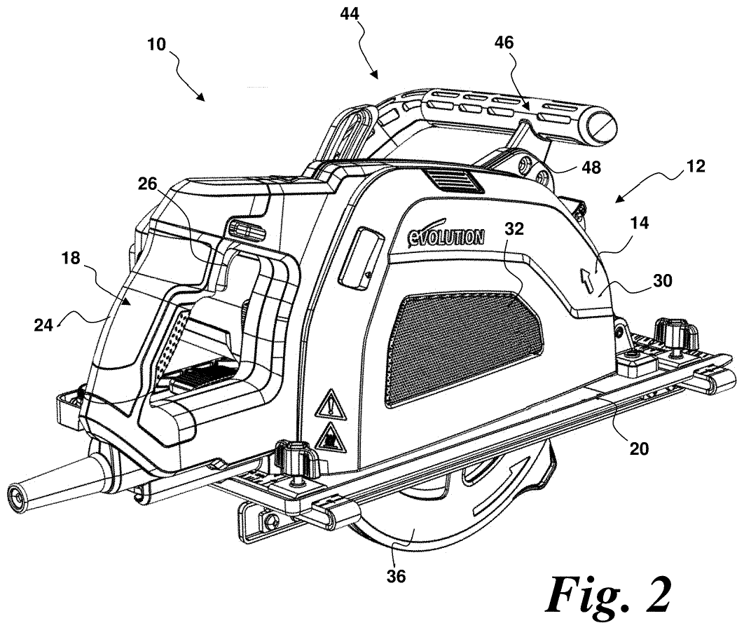

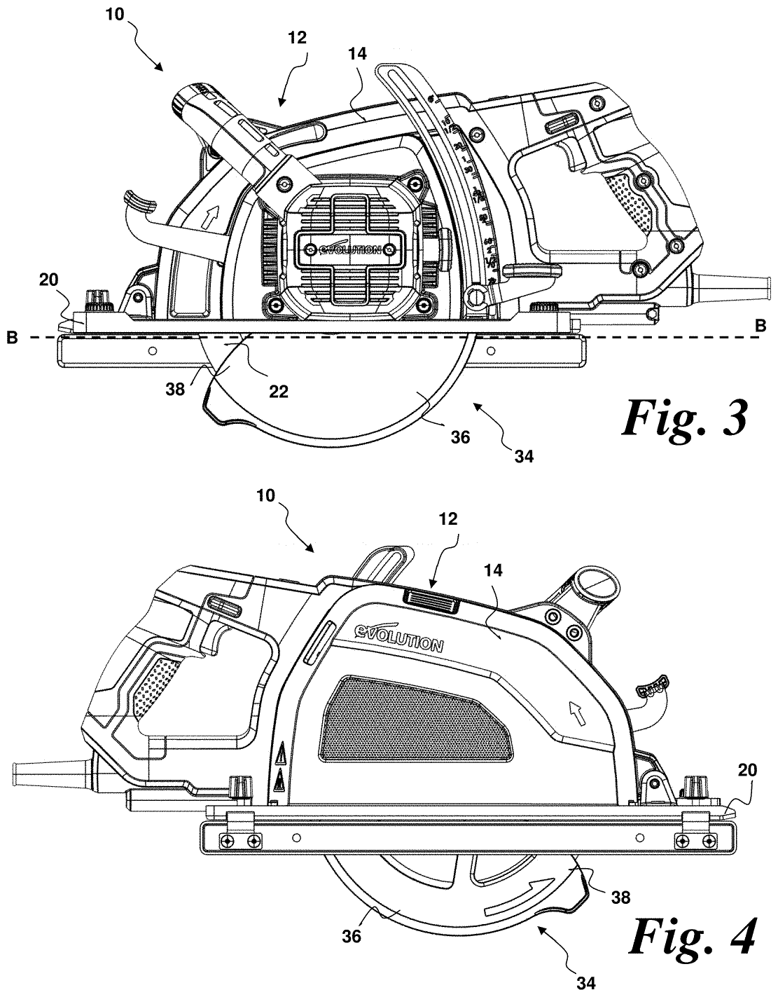

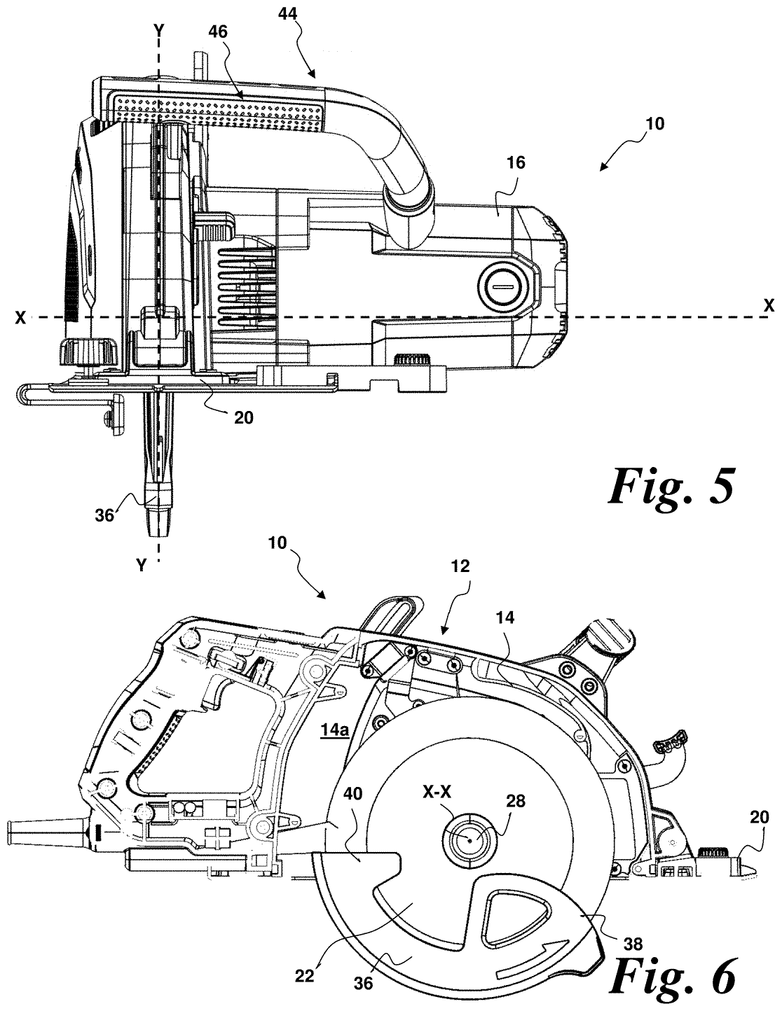

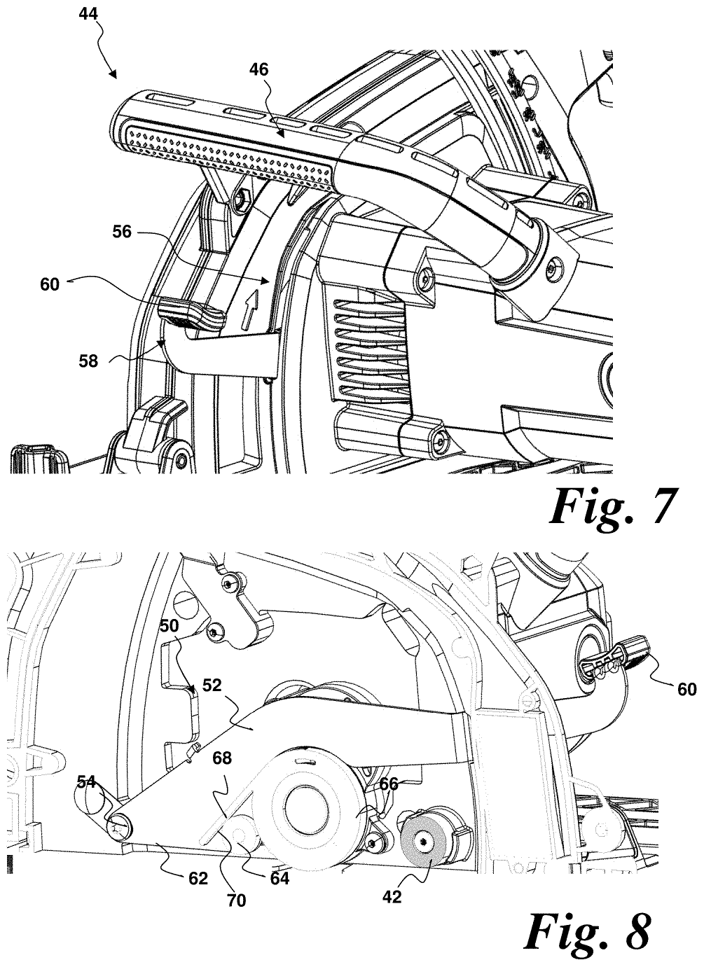

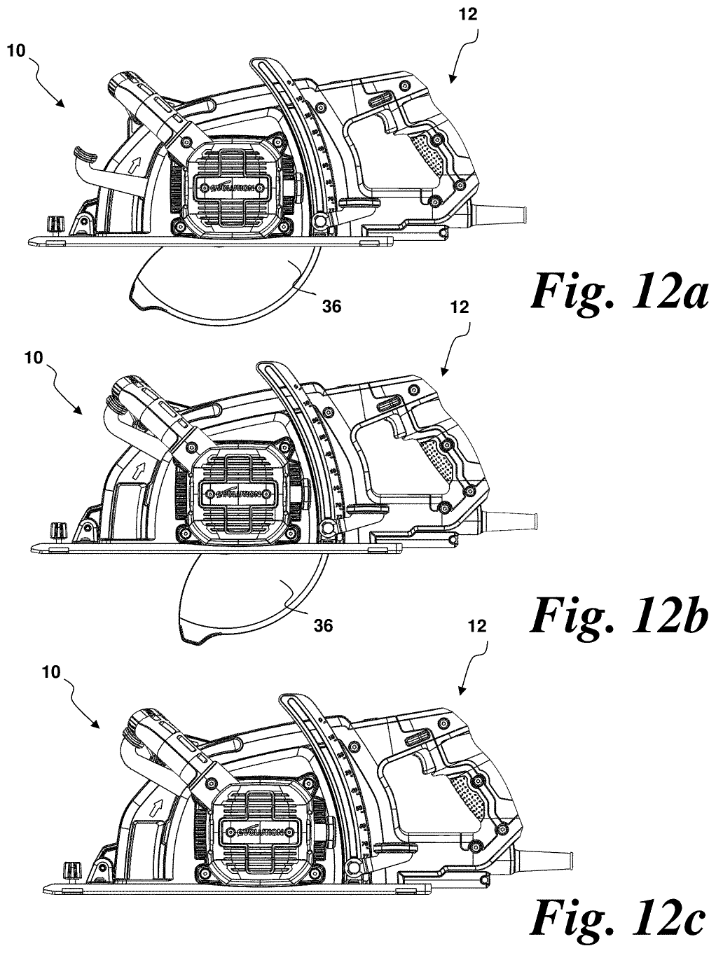

FIGS. 1 to 8 show a circular saw 10 according to an embodiment. FIG. 1 shows a front perspective view and FIG. 2 a rear perspective view. FIGS. 3 and 4 show side views of the circular saw 10. FIG. 5 shows a front view of the saw 10. FIG. 6 shows detailed view of the circular saw 10, and FIGS. 8 to 11 then show a specific movable blade guard actuation mechanism in detail according to an embodiment. FIGS. 12a to 12c show a movable blade guard in various positions in use.

The circular saw 10 comprises a main body 12. The main body 12 comprises a fixed blade guard 14, a motor housing 16 and a rear handle assembly 18. The main body 12 is attached to a base plate 20 at a lower end thereof.

The fixed blade guard 14 defines a cavity 14a (FIG. 6) arranged to contain and surround the upper portion of a circular blade 22. The motor housing 16 is generally rectangular and extends perpendicular to the fixed blade guard 14. The motor housing 16 comprises an electric motor unit (not shown) for driving the blade 22 through a reduction gear assembly (not shown). The rear handle assembly 18 comprises a rear graspable handle 24 arranged to be grasped by a user's hand in use. A trigger 26 is provided to enable the user to activate the circular saw 10 whilst grasping the rear handle 24.

With particular reference to FIG. 6, the fixed blade guard 14 partially surrounds a circular cutting blade 22 which may have any suitable cutting edge. For example, the cutting blade 22 may be configured to cut metal, wood or any other suitable material and may have toothed profile, a continuous edge, or other form. The skilled person would readily appreciate the types of blade which could be used with the circular saw 10.

The cutting blade 22 is arranged on a rotatable shaft 28 which is rotatable about an axis of rotation X-X (FIG. 5). The axis of rotation X-X is substantially perpendicular to a vertical axis Y-Y (FIG. 5) of the main body 12. The rotatable shaft 28 is driven by the electric motor unit through the reduction gear assembly (not shown). The electric motor unit is arranged perpendicular to the plane Y-Y within the motor housing 16. By this is meant that the motor rotates about an axis which is substantially parallel to the axis of rotation X-X of the blade 22. In this embodiment, an electric AC motor driven from an electrical supply. However, this need not be the case and a DC motor may be used, or a motor driven from a battery source. Alternatively, an alternative power source (e.g. a petrol motor) may be used.

As shown in FIGS. 3, 4, 5 and 6, the location and orientation of the axis of rotation X-X and blade 22 is such that a significant portion of the blade 22 extends below the line B-B (FIG. 3) of the base plate 20. The base plate 20 has a longitudinal aperture (not shown) formed therein to allow the blade 22 and associated components (discussed below) to extend therethrough.

The fixed blade guard 14 further comprises a removable chip collector 30 having a vent 32 (FIG. 2). The chip collector 30 is configured such that metal or wood chips from a cutting process are guided through the cavity 14a and into the chip collector 30 for subsequent disposal.

A guard assembly 34 is arranged on the fixed blade guard 14 and comprises a movable blade guard 36 which surrounds at least a part of the cutting blade 22 extending below the base plate. The movable blade guard 36 is rotatably connected to the main body 12 about the axis of rotation X-X.

In use, the movable blade guard 36 is designed to protect the user from the rotating blade 22. In addition, the movable blade guard 36 shields the user from flying chips. The movable blade guard 36 has a leading edge 38, a trailing edge 40 and extends around an arc of the blade 22. In non-limiting embodiments this arc is approximately 136 degrees although this is not material to the present invention and any suitable value may be taken. For example, the arc may in the range of 120 to 160 degrees.

The movable blade guard 36 is continuously movable between first, second and third positions as will be described below. The first position is shown in FIGS. 1 to 11 and 12a. The second position is shown in FIG. 12b, and the third position is shown in FIG. 12c. This will be described below.

In the first position shown in FIGS. 1 to 11 and 12a, the movable blade guard 36 is in an extended position where only a small portion of the blade 22 is exposed. In a non-limiting embodiment, the exposed angle of the blade 22 between the base plate 20 and the leading edge 38 of the movable blade guard 36 is approximately 24 degrees. However, this is not intended to be limiting and other values for this exposed angle may be taken. For example, the exposed angle of the blade when in the first position may be between 20 and 45 degrees. In non-limiting embodiments, the movable blade guard 36 may be biased into the first position by means of a coil spring (not shown).

The second position of the movable blade guard 36 is shown in FIG. 12b. The second position is a position of the movable blade guard 36 when retracted by the actuator arrangement 50 (described below). The angle of the blade 22 which is exposed when the movable blade guard 36 is retracted in the second position may selected as appropriate. It may be selected such that a majority of the blade 22 below the base plate 20 is exposed, or it may be such that only a relatively smaller further portion of the blade 22 below the base plate 20 is exposed. This may be selected as appropriate. In addition, detents or other components may be used to hold the movable blade guard 36 in a specific position between the first and second positions as appropriate. It is to be understood that the second position of the movable blade guard 36 is simply a different position from the first position and where in the second position more of the blade 22 is exposed than when the movable blade guard 36 is in the first position.

The third position of the movable blade guard 36 is shown in FIG. 12c. In the third position, the movable blade guard 36 is retracted to the limit of its travel. As shown in FIG. 12c the third position is when the movable blade guard 36 is fully retracted to expose all the cutting blade 22 below the base plate. However, this need not be the case and any suitable third position may be used. It is noted that the third position cannot be reached through activation of the actuator arrangement 50 alone. It is necessary to move the movable blade guard 36 manually to reach the third position. In other words, the first and second positions comprise the positions of the movable blade guard 36 which are selectable via the actuator arrangement 50, and the third position is selectable only through manual or otherwise manipulation of the movable blade guard 36.

However, this need not be the case and variants would be readily apparent to the skilled person. For example, there may not be a third position at all and the actuator arrangement 50 may be capable of moving the movable blade guard 36 from the first position to a second position which is the limit of the travel of the movable blade guard 36 and/or a fully retracted position as illustrated by the third position described above. Further variations will be apparent to the skilled person.

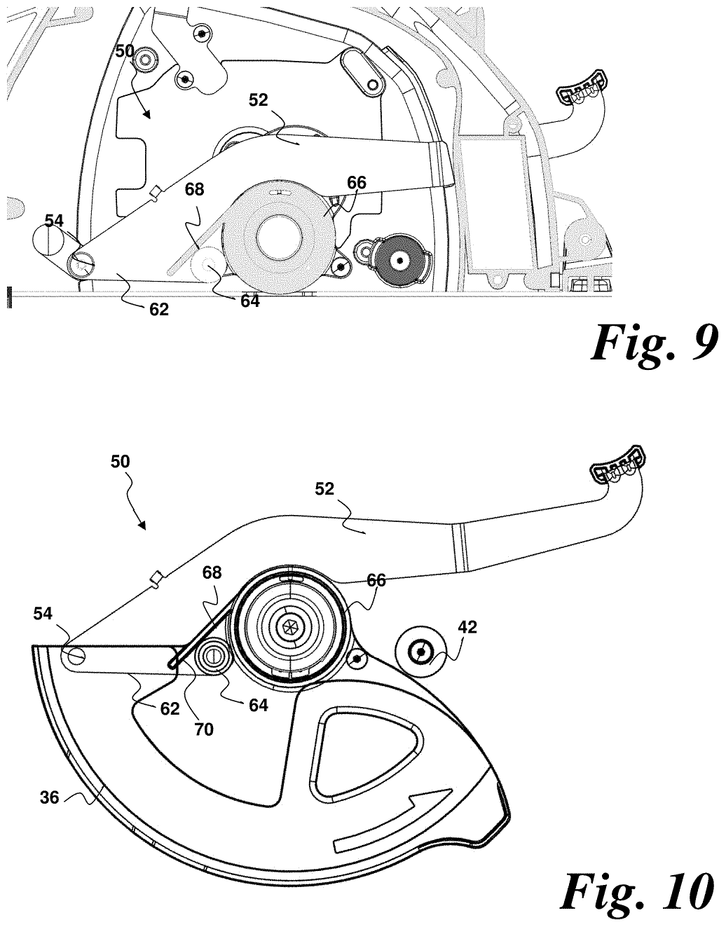

When the movable blade guard 36 retracts, the movable blade guard 36 rotates about the axis X-X in a clockwise direction (with reference to FIG. 6) and partially retracts into the cavity 14. When in the first position, the movable blade guard 36 is prevented from moving further forward by a rubber stopper 42 (FIGS. 8 and 9)

The main body 12 comprises a forward handgrip assembly 44. The forward handgrip assembly 44 may be formed from any suitable material; for example, metal or plastic. If formed from metal, the handgrip assembly 44 maybe powder coated or plastic coated for user convenience.

The handgrip assembly 44 extends forwards and upwards from an upper portion of the motor housing 16 and across the fixed blade guard 14. The handgrip assembly 30 comprises a handgrip 46 which is arranged generally perpendicular to the vertical axis Y-Y of the main body 12 (FIG. 5) such that the handgrip 46 extends across the longitudinal axis Y-Y. In other words, the handgrip 46 crosses the central vertical plane of the main body 12 and the plane of the blade 22. The handgrip 46 is arranged to be gripped by a user in use and is the portion of the handgrip assembly 44 most likely to be held by a user whilst the circular saw 10 is in use.

The handgrip 46 is secured to the upper part of the fixed blade guard 14 by means of a connection 48. This ensures that the handgrip 46 is anchored to the main body 12 in two places—on the motor housing 16 and on the fixed blade guard 14.

In use, the user may wish to manually adjust the position of the movable blade guard 36. In many use situations, a user may wish to retract the movable blade guard 36 beyond its current position to expose more of the cutting blade 22. This may be in situations where, for example, impingement of the leading edge 38 of the movable blade guard 36 may damage the workpiece, or where the workpiece is a flat sheet and may be prone to jamming between the base plate 20 and the movable blade guard 36.

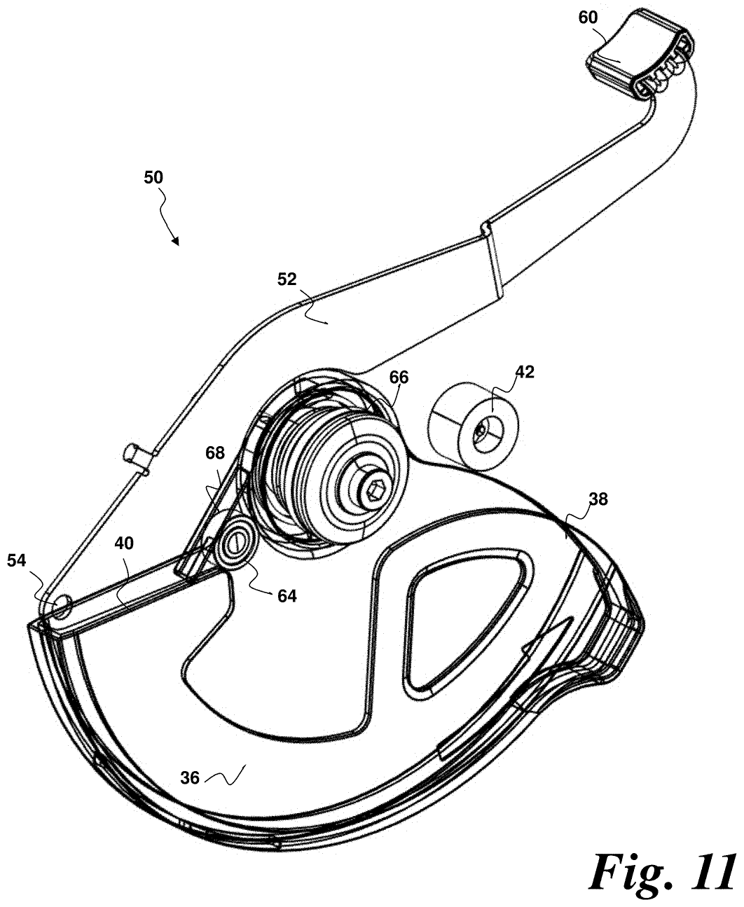

In order to move the movable blade guard 36 manually, an actuator arrangement 50 is provided. The actuator arrangement 50 is shown in FIGS. 6 to 11. The components and mechanism of operation of the actuator arrangement 50 will now be described with reference to FIGS. 8 to 11. FIGS. 8 and 9 show the actuator arrangement 50 in situ in the guard cavity 14a in a section view taken along a plane parallel to Y-Y. FIGS. 10 and 11 show the actuator arrangement 50 and movable blade guard 36 separate from the other components.

The actuator arrangement 50 comprises an actuator arm 52. The actuator arm 52 is connected to the guard housing 14 at a pivot point 54 (FIG. 8) and pivotable thereabout. The actuator arm 52 is arranged to pivot about an axis parallel to the axis of rotation X-X of the cutting blade 22.

The actuator arm 52 extends from the pivot point 54 within the cavity 14a of the guard housing 14 and through a slot 56 formed in the front of the guard housing 14. The slot 56 delimits the movement of the actuator arm 52.

The actuator arm 52 has a distal end 58 which terminates in a user-graspable actuator grip 60. The distal end 56 curves upwardly to present the actuator grip 60 towards a user's hand grasping the handgrip 46 in use.

The actuator arrangement 50 and actuator arm 52 is movable between first and second positions. The actuator arrangement 50 is shown in the first position in the figures. In the first position, the actuator arm 52 is at a lowermost position and rests at the base of the slot 56. In the first position of the actuator arrangement 50, the movable blade guard 36 is in the first position.

In use, if a user wishes to move the movable blade guard 36 from the first position to the second position where the movable blade guard 36 is further retracted and so more of the blade 22 is exposed, a user pulls the actuator grip 60 upwards towards the handle 32. The handle 32 and actuator grip 60 are configured and arranged such that this can be done with the fingers of a user's hand that is gripping the handgrip 46. This may be either the user's left or right hand. The other of the user's hands will, in use, be gripping the rear graspable handle 24.

The action of grasping the actuator grip 60 with one or more fingers of the hand supported by the handgrip 46 is natural and in sympathy with the user's movements during cutting of a material.

To explain, when cutting a workpiece, the user will position the circular saw 10 in the correction alignment and position on the workpiece to achieve the desired cut, then the user will advance the circular saw 10 to cut the workpiece. The saw 10 is advanced by a substantially horizontal force applied by the user through the rear graspable handle 24 and the handgrip 46. Thus, the user applies the necessary horizontal force from their palms with the user's fingers being used to secure the user's hands in position.

It is then an easy motion for the user to activate the actuator grip 60 by extending their fingers from the handgrip 46 and, if necessary, rotating their wrist. The actuator grip 60 can then be pulled by the user's fingers upwards and rearwards towards the handgrip 46.

This is a natural motion for a user and enables the user to maintain forward pressure on the handgrip 46 using their palms and thumb. This is in contrast to known arrangements whereby the user must activate an actuator at the rear of the handgrip using their thumb.

In contrast to the present invention, known arrangements require a user to apply a rearward force on a handgrip to counterbalance the action of their thumb on the actuator, contrary to the intended forward travel of a saw. This makes the operation less intuitive, more strenuous and may result in poorer control of a saw and the cuts achieved by the saw.

The mechanism for actuating the movable blade guard 36 movement will now be described.

As described above, a pivot 54 for the actuator arm 52 is provided rearwardly of the axis of rotation X-X of the blade 22 and the movable blade guard 36. The actuator arm 52 has a base surface 62 which, in the first position, is substantially parallel to the base plate 20. A rotary bearing 64 is connected to a portion of the base surface 62 adjacent the axis X-X.

The rotary bearing 64 is positioned so as to create a moment arm between the bearing 64 and the pivot 54. In other words, the base surface 62 acts as a lever connected between the pivot 54 and the bearing 64. The bearing 64 and base surface 62 is configured such that the angle between a straight line between the bearing 64 and the pivot 54, and a straight line between the actuator grip 60 and the pivot 54 is, in non-limiting embodiments, 19 degrees. However, other angles may be used as appropriate, for example, a range between 15 and 30 degrees could be used.

Nevertheless, the skilled person would readily be aware of variations that would fall within the scope of the present invention. Provided the bearing 64 is spaced from the pivot 54 and on the same side of the pivot 54 as the actuator grip 60 other arrangements could be contemplated

The movable blade guard 36 has a hub portion 66 and a ramp 68 extending therefrom. The ramp 68 is angled downwardly in this embodiment and has a ramp surface 70. The ramp surface 70 is located above the bearing 64 and engages therewith. In other words, the ramp 68 is located between the bearing 64 and the pivot 54 and rests on the bearing 64 when in the first position shown in FIGS. 8 to 11.

In use, when the user lifts the actuator grip 60, the actuator arm 52 is raised and rotated anti-clockwise (relative to the orientation shown in FIGS. 8 to 11) about the pivot 54. Due to the spacing between the pivot 54 and the bearing 64, the bearing 64 is raised and rolls against the ramp surface 70. This causes the ramp surface 70 to move upwards in a clockwise direction (as shown in FIGS. 8 to 11), rotating the whole movable blade guard 36 in a clockwise direction, exposing more of the cutting blade 22 in use.

Thus the movable blade guard 36 can be moved from the first position to the second, more retracted, position, easily and cleanly by the actuator arrangement 50. This is assisted by the larger moment arm between the actuator grip 60 and the pivot 54 than that between the bearing 64 and the pivot 54 which improves the user's leverage and control over the movement of the movable blade guard 36.

In addition, the configuration of the actuator arrangement 50, in which the actuator grip 60 is moved in a rotational direction opposite to the direction of rotation of the movable blade guard 36 means that an optimal configuration can be provided for user efficiency of operation.

This is in direct contrast to known arrangements which an actuator engages directly with a blade guard on an opposite side of a pivot point to the portion that the user activates, so that a blade guard in such a configuration moves in the same rotational direction as the actuator.

Variations of the above embodiments will be apparent to the skilled person. The precise configuration of components may differ and still fall within the scope of the present invention.

For example, the ramp surface 70 is shown in the illustrated embodiment as a straight surface. This imparts an angular movement of the movable blade guard 36 which is proportional to the angular movement of the actuator arm 52.

However, this need not be so, and particular ramp profiles may be used to impart different angular rotation profiles of the movable blade guard 36. For example, the ramp surface 70 may be arranged such that a small movement of the actuator arm 52 initially imparts a large movement of the movable blade guard 36.

For example, whilst the above description relates to a circular cutter power tool in the form of a handheld circular saw for cutting metal or wood, the present invention is suitable for use with other cutter power tools using a circular blade. For example, an angle grinder, a disc cutter, a stone cutter or any other suitable handheld power tool. The skilled person would readily be aware of variations which could be used with the present invention.

Embodiments of the present invention have been described with particular reference to the examples illustrated. While specific examples are shown in the drawings and are herein described in detail, it should be understood, however, that the drawings and detailed description are not intended to limit the invention to the particular form disclosed. It will be appreciated that variations and modifications may be made to the examples described within the scope of the present invention.

1. A handheld circular saw comprising:
a main body comprising a fixed blade guard configured to receive a circular cutting blade having an axis of rotation;
a graspable handle arranged in a forward position on the main body to enable a user to wield the power tool in use;
a movable blade guard arranged to surround at least a part of the cutting blade; and
an actuator arrangement configured to move the movable blade guard from a first position to a second position, wherein a greater proportion of the cutting blade is exposed in the second position than in the first position, the actuator arrangement having an actuator grip to enable the user to activate the actuator arrangement, wherein the actuator grip is located and arranged forwardly of the graspable handle to enable actuation by the fingers of the user's hand which is grasping the graspable handle in use.

2. A handheld circular saw according to claim 1, wherein the actuator arrangement further comprises an actuator arm arranged to engage with a part of the movable blade guard to move the blade guard from the first position to the second position.

3. A handheld circular saw according to claim 2, wherein the actuator arm comprises the actuator grip at a distal end.

4. A handheld circular saw according to claim 2, wherein the actuator arm has a pivotable connection to the fixed blade guard at a proximal end thereof.

5. A handheld circular saw according to claim 4, wherein the movable blade guard is rotatable between the first and second positions about an axis of rotation.

6. A handheld circular saw according to claim 5, wherein the movable blade guard is rotatable about an axis of rotation coincident with the axis of rotation of the cutting blade.

7. A handheld circular saw according to claim 5, wherein the actuator arm and movable blade guard comprise complimentary engagement arrangements to facilitate movement therebetween.

8. A handheld circular saw according to claim 7, wherein the engagement arrangements are located between the pivotable connection and the axis of rotation of the movable blade guard.

9. A handheld circular saw according to claim 8, wherein the engagement arrangements comprise a rotatable bearing on one part and a ramp on the other part.

10. A handheld circular saw according to claim 9, wherein the actuator arm comprises the rotatable bearing and the guard housing comprises the ramp.

11. A handheld circular saw according to claim 9, wherein the ramp has a straight or a curved profile.

12. A handheld circular saw according to claim 9, wherein the rotatable bearing is spaced from the pivotable connection between the pivotable connection and the actuator grip.

13. A handheld circular saw according to claim 12, wherein the rotatable bearing is offset from a line connecting the pivotable connection and the actuator grip.

14. A handheld circular saw according to claim 7, wherein the engagement arrangements on the actuator arm are arranged below the engagement arrangements on the blade guard such that lifting the actuator arm causes engagement between the complimentary engagement arrangements.

15. A handheld circular saw according to claim 1, further comprising a base plate connected to a lower end of the main body and arranged such that at least a part of the cutting blade extends below the main body through an aperture in the base plate in use.

16. A handheld circular saw according to claim 1, wherein cutting blade is rotatable about a substantially horizontal axis in use.

17. A handheld circular saw according to claim 1, further comprising an electrical motor located within the main body.

18. A handheld circular saw according to claim 1, wherein the graspable handle is spaced from the main body and/or wherein the graspable handle is arranged substantially parallel to the axis of rotation of the cutting blade.

19. A handheld circular saw according to claim 1, wherein the actuator grip is movable between first and second positions, wherein in the second position the actuator grip is closer to the graspable handle than in the first position and/or wherein the actuator grip is movable between first and second positions in a substantially vertical plane.

20. A handheld circular saw according to claim 1, wherein the movable blade guard is movable to a third position beyond the second position, wherein a greater proportion of the cutting blade is exposed in the third position relative to the first and second positions.

21. A handheld circular saw comprising:
a main body configured to receive a rotatable circular cutting blade in use;
a graspable handle arranged forwardly on the main body to enable a user to wield the power tool in use;
a movable blade guard arranged to surround at least a part of the cutting blade; and
an actuator arrangement configured to move the movable blade guard between a first position and a second position, wherein a greater proportion of the blade is exposed in the second position than in the first position, the actuator arrangement having an actuator arm comprising an actuator grip manipulable by a user, wherein the actuator arrangement is configured and arranged such that movement of the actuator arm in a first direction causes the movable blade guard to move in a second direction opposite to the first direction.

22. A handheld circular saw according to claim 21, wherein the actuator arrangement is configured and arranged such that rotation of the actuator arm in a first direction causes the movable blade guard to rotate in a second direction opposite to the first direction of rotation.
